(19) United States
(12) Patent Application Publication
(10) Pub. No.: US 2026/0180185 A1
(43) Pub. Date: Jun. 25, 2026

(54) STACKED PATCH ANTENNA

(71) Applicant: AIRBUS DEFENCE AND SPACE S.A., Madrid (ES)

(72) Inventor: David ESPINOSA ADAMS, Getafe, Madrid (ES)

(21) Appl. No.: 18/711,466

(22) PCT Filed: Nov. 17, 2021
(86) PCT No.: PCT/ES2021/070831

§ 371 Date: May 17, 2024

(51) Int. Cl. H01Q 9/04

(52) U.S. Cl. CPC H01Q 9/045; H01Q 9/0407

(57) ABSTRACT

A stacked patch antenna includes at least an upper patch antenna with a radiating element and a lower patch antenna with a radiating element. The upper patch antenna is a cavity backed patch antenna with a wall laterally surrounding the radiating element. The lower patch antenna is a cavity backed patch antenna with a wall laterally surrounding both the radiating element of the lower patch antenna and the upper patch antenna. The upper patch antenna has a quarter wavelength shunt stub as parasitic element.

### FIELD OF THE INVENTION

The invention belongs to the field of patch antennas that are arranged in a stack, and that can be used, for instance, in satellite communications. The stack comprises at least an upper patch antenna and a lower patch antenna.

### BACKGROUND OF THE INVENTION

There are several patent documents relating to the technology of patch antennas arranged in a stack. For example, EP 1341259 B1 discloses a stacked patch antenna that comprises a plurality of patch antennas having respective operating frequency bands arranged in a stack, each antenna comprising a radiating conductive patch and a cable having a plurality of coaxial conductors separated from each other by dielectric. A first conductor of the cable carries the feed signal for the uppermost antenna and is conductively coupled to a null point of its radiating conductive patch and passes through apertures at the null points of the other ones of the antennas in the stack. Each of the successively lower antennas in the stack is coupled to another one of the plurality of conductors of the cable, which conductors reference the other patches to ground. With this arrangement, high isolation is maintained between the frequency operating bands. Another antenna can be added between each consecutive pair of antennas discussed above, these antennas being fed by the same feed conductor as the antenna above it by parasitic coupling with the antenna above it.

US 20180358701 A1 (“Stacked self-diplexed dual-band patch antenna”) discloses an antenna having an electrically conductive base. In some embodiments, a first radiating element may overlie the electrically conductive base and be operative in a first frequency band. A second radiating element may overlie the first radiating element and have a footprint smaller than the first radiating element. The second radiating element may be operative in a second frequency band. The second radiating element may overlie the first radiating element by a distance such that isolation between the feed lines of respective first and second radiating elements, in the first and second frequency bands, is greater than or equal to 15 dB.

US 2019252800 A1 (“Self-multiplexing antenas”) discloses a self-multiplexing antenna that includes a substrate, a first antenna element carried by the substrate, the first antenna element including a first antenna patch, and a first antenna reflector, a first signal feed connected with the first antenna patch, a second antenna element carried by the substrate, wherein the second antenna element is at least partially vertically aligned with the first antenna element, the second antenna element including a second antenna patch, and a second antenna reflector, a second signal feed connected with the second antenna patch, and a first isolator cavity between the second antenna reflector and the first antenna patch.

A diplexer is an element that is usually employed to separate signals in the two frequency bands.

Usually, in a stacked patch antenna the electric fields radiated by the lower antenna induce surface currents on the upper antenna, and the electric fields radiated by the upper antenna induce surface currents on the lower antenna.

Accordingly, there is a need to provide a stacked patch antenna with multi-frequency performance that enhances the isolation between frequency bands.

### SUMMARY OF THE INVENTION

The object of the invention is to provide a stacked patch antenna that overcomes the mentioned drawbacks.

The invention provides a stacked patch antenna that comprises at least an upper patch antenna with a radiating element and a lower patch antenna with a radiating element, wherein the upper patch antenna is a cavity backed patch antenna with a wall laterally surrounding the radiating element, the lower patch antenna is a cavity backed patch antenna with a wall laterally surrounding both the radiating element of the lower patch antenna and the upper patch antenna, and the upper patch antenna comprises a quarter wavelength shunt stub as parasitic element.

The concept of using a cavity backed antenna inside a cavity backed antenna offers a novel compact design with high isolation for multi-frequency bands and wide circular polarization capabilities. The isolation is improved with the incorporation of a quarter wavelength shunt stub as parasitic element in the upper patch antenna. This element reduces the effective section area, providing higher isolation.

The quarter wavelength shunt stub maximizes circular polarization capabilities, as a purer circular polarisation and a smoothing of the axial ratio in the coverage are achieved.

The fact that the quarter wavelength shunt stub is less visible than a circular patch reduces leakage. This parasitic element achieves what other antennas with dielectrics achieve in terms of bandwidth attainment.

The isolation can be further improved with the incorporation of stepped impedance concentric rings over the upper antenna ground plane, which allow to perform very good isolation capabilities.

Other characteristics and advantages of the present invention will be clear from the following detailed description of several embodiments illustrative of its object in relation to the attached figures.

### BRIEF DESCRIPTION OF DRAWINGS

FIG. 1 shows a perspective view of the stacked patch antenna of the invention.

FIG. 2 shows a plan view of the stacked patch antenna of FIG. 1.

FIG. 3 shows a cross view of the stacked patch antenna of FIG. 1.

FIG. 4 shows a view in section of a stacked patch antenna of the invention.

### DETAILED DESCRIPTION OF THE INVENTION

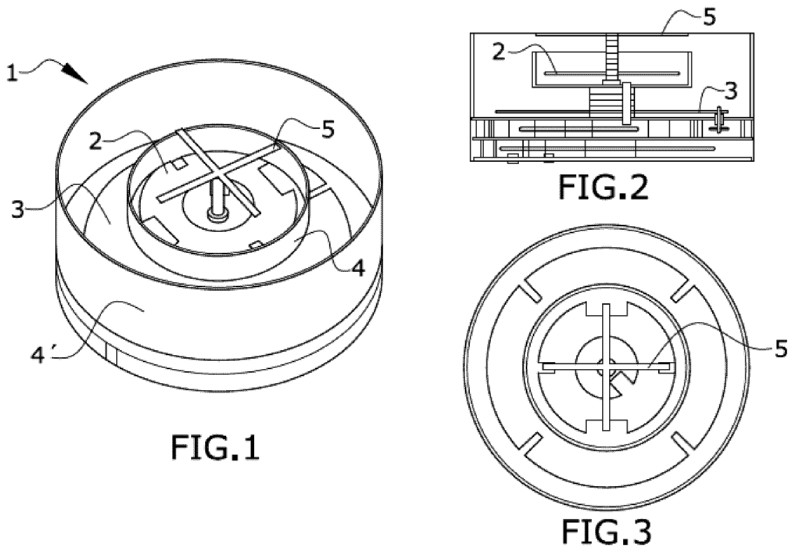

The invention discloses a stacked patch antenna 1 shown in FIGS. 1 to 4 in different views.

The stacked patch antenna 1, as seen in the embodiment of FIGS. 1 to 3, comprises an upper patch antenna 2 with a radiating element and a lower patch antenna 3 with a radiating element. The upper patch antenna 2 is a cavity backed patch antenna with a wall 4 laterally surrounding the radiating element. The lower patch antenna 3 is a cavity backed patch antenna with a wall 4′ laterally surrounding both the radiating element of the lower patch antenna 3 and the upper patch antenna 2. The upper patch antenna 2 comprises a quarter wavelength shunt stub 5 as parasitic element.

This arrangement of the stacked patch antenna 1 allows to achieve a compact and integrated solution, with an isolation that is greater than 20 dB.

Two stacked cavity backed patch antennas with reduced coaxial sizes with small sizes with respect to the wavelength allow to work in two bands simultaneously with good isolation between bands. This allows low volume, low mass and good performance.

It can be used for transmission and reception telecommunications or for two transmission signals (telecommunications or Navigation).

The isolation can be tuned by rotation of the quarter wavelength shunt stub 5 with respect to the vertical axis (Z axis). Additionally, this parasitic element is used to provide a better axial ratio flatness, improving significantly the circular polarization purity with respect to a single notched patch.

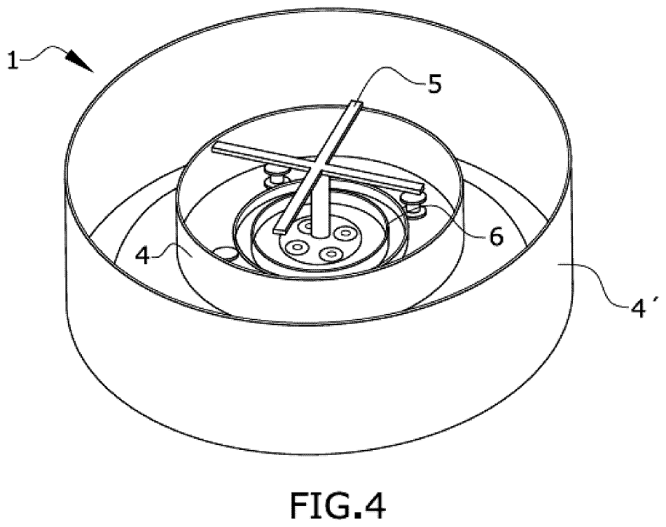

In an embodiment, the stacked patch antenna 1 additionally comprises stepped impedance concentric rings (SICR) 6 over the upper patch antenna ground plane (as shown in FIG. 4). These rings are used to provide a better isolation performance (fine tuning).

In the stacked patch antenna 1 of the invention the currents caused by the lower patch antenna 3 do not enter the upper patch antenna 2, and the currents caused by the upper patch antenna 2 do not enter the lower patch antenna 3. Currents do not flow in and out, and there is no electromagnetic coupling between patch antennas. No diplexer unit is required to separate the bands, saving mass.

In an embodiment the stacked patch antenna 1 is a fully metallic antenna, with no dielectric substrates.

The stack may also comprise more than two patch antennas.

Although the present invention has been fully described in connection with preferred embodiments, it is evident that modifications may be introduced within the scope thereof, not considering this as limited by these embodiments, but by the contents of the following claims.

1. A stacked patch antenna comprises at least an upper patch antenna with a radiating element and a lower patch antenna with a radiating element, wherein the lower patch antenna is a cavity backed patch antenna with a wall laterally surrounding both the radiating element of the lower patch antenna and the upper patch antenna, wherein the upper patch antenna is a cavity backed patch antenna with a wall laterally surrounding the radiating element, and wherein the upper patch antenna comprises a quarter wavelength shunt stub as parasitic element.

2. The stacked patch antenna according to claim 1, wherein the upper patch antenna additionally comprises stepped impedance concentric rings over the upper patch antenna ground plane.

3. The stacked patch antenna according to claim 1, wherein the walls are cylindrical.

4. The stacked patch antenna according to claim 1, the stacked patch antenna being fully metallic.
